(19) United States
(12) Patent Application Publication
(10) Pub. No.: US 2018/0194056 A1
(43) Pub. Date: Jul. 12, 2018

(54) Print bed levelling system and methods for additive manufacturing

(71) Applicant: Ultimaker B.V., Geldermalsen (NL)

(72) Inventor: Erik van der Zalm, Eindhoven (NL)

(73) Assignee: Ultimaker B.V., Geldermalsen (NL)

(21) Appl. No.: 15/913,968

(22) Filed: Mar. 7, 2018

Related U.S. Application Data
(63) Continuation-in-part of application No. 15/246,776, filed on Aug. 25, 2016.

(30) Foreign Application Priority Data
Aug. 28, 2015 (NL) 2015361

(51) Int. Cl. B29C 47/92; B29C 64/209; B29C 64/106; B29C 47/12

(52) U.S. Cl. CPC B29C 47/92; B29C 64/209; B29C 64/106; B33Y 10/00; B29C 2947/92133; B29C 2947/92571; B29C 2947/92904; B29C 47/12

(57) ABSTRACT

A print bed levelling system for an additive manufacturing system includes a nozzle head assembly movably arranged with respect to a substantially flat print bed member, wherein the nozzle head assembly comprises one or more nozzle bodies, and a contactless sensor member disposed at a print bed engagement end of the nozzle head assembly. The contactless sensor member includes a sensing surface in sensing engagement with the print bed member over a relative sensing distance range between a distal sensing position and a proximal sensing position.

### FIELD OF THE INVENTION

The present invention relates to print bed levelling systems, in particular to a print bed levelling system for use in additive manufacturing. In a further aspect the present invention relates to vertical probing methods and lateral scanning methods of print bed levelling for print bed levelling systems.

### PRIOR ART

US patent application US 2013/0242317 A1 (Leavitt et al.) discloses a method for calibrating a print head for use in an additive manufacturing system. The method comprises positioning the print head over a calibration target, where the calibration target has a top surface with a plurality of edges. The method further comprises moving a tip of the print head to identify coordinate locations of the edges, and setting a calibration parameter for the print head. In an embodiment, a linear encoder may be utilized to monitor elevation changes of the print head relative to a head carriage when the print head drops of the top surface of the calibration target.

### SUMMARY OF THE INVENTION

The present invention seeks to provide an improved print bed levelling system for use in additive manufacturing, wherein the print bed levelling system allows for accurate position calibration of one or more nozzle bodies relative to a print bed or platen onto which material can be deposited during an additive manufacturing process. The print bed levelling system is robust to various external factors such as temperature changes, humidity levels as well to the collection of dirt and waste material onto components of the print bed levelling system.

According the present invention a print bed levelling system of the type defined in the preamble is provided, wherein the print bed levelling system comprises a nozzle head assembly movably arranged with respect to a substantially flat print bed member, the nozzle head assembly comprising one or more nozzle bodies each having a nozzle end, and a contactless sensor member disposed at a print bed engagement end of the nozzle head assembly, wherein the contactless sensor member comprises a sensing surface in sensing engagement with the print bed member over a relative sensing range between a distal sensing position and a proximal sensing distance.

The print bed levelling device of the present invention allows cost effective yet accurate and reliable position calibration of one or more nozzle bodies with respect to a print bed member. Various perturbing factors and disturbances such as temperature changes, humidity levels, print bed contamination and the like are minimized through the contactless sensor member.

In an embodiment, the sensing surface of the contactless sensor member is fixedly attached to the print bed engagement end of the nozzle head assembly, so that synchronous displacement is obtained of the contactless sensor member and the nozzle head assembly. Movement of the contactless sensor member immediately corresponds with equal movement of the nozzle head assembly to facilitate position calibration of the one or more nozzle bodies with respect to the print bed member.

In a further embodiment the sensing surface of the contactless sensor member is arranged adjacent to the one or more nozzle ends of the one or more nozzle bodies, so that measurement accuracy of the contactless sensor member is improved.

In a further embodiment, the sensing surface of the contactless sensor member is a flat surface substantially parallel to the print bed member, thereby allowing for a large sensing area that can be in close proximity to the print bed member to also improve measurement accuracy. Further, to ensure that the sensing surface does not come into contact with the print bed member, an embodiment is provided wherein the one or more nozzle bodies, in particular each nozzle end thereof, are positioned closer to the print bed member than the sensing surface.

In an embodiment the one or more nozzle bodies are relatively movable with respect to one another, so that each nozzle body may become (but need not) an active nozzle body during an additive manufacturing process by positioning it accordingly. Remaining nozzle bodies may then be positioned in an inactive position for avoiding interference with the active nozzle as it deposits material during an additive manufacturing process.

In a further embodiment a primary nozzle of the one or more nozzle bodies may be provided which is immovable with respect to the sensing surface and one or more secondary nozzles of the one or more nozzle bodies may be provided which are relatively movable with respect to the primary nozzle. In a typical embodiment, the primary nozzle is fixedly attached to the nozzle head assembly and the secondary nozzle bodies are movably attached to the nozzle head assembly.

The contactless sensor member allows for a variety of different sensing technologies for accurate print bed levelling. For example, in an embodiment the print bed member comprises electrically conductive material and the contactless sensor member comprises a capacitive displacement sensor in capacitive sensing engagement with the print bed member. This embodiment allows not only for accurate measurement but is also very reliable as any the conductive print bed member can be readily detected. Capacitive sensing is very robust to print bed contamination and dimensional offsets, inaccuracies etc., but also changing atmospheric conditions do not have a significant impact on measurement accuracy and reliability. Other advantages of the capacitive displacement sensor is stability and speed of measurement, high measurement resolution and low power usage.

In a further embodiment, the print bed member comprises electrically conductive material and the contactless sensor member comprises an inductive displacement sensor in inductive sensing engagement with the print bed member. The inductive displacement sensor also provides high accuracy and reliably when subject to changing conditions such as temperature and humidity levels. Another advantage of the inductive displacement sensor is that delicate processing circuitry need not be disposed near the inductive displacement sensor within the nozzle head assembly but can be conveniently located elsewhere in the print bed levelling system. Inductive displacement sensors can also be regarded as being maintenance free.

In yet a further embodiment, the contactless sensor member may comprise an echo-sonar displacement sensor or ultrasonic displacement sensor in acoustic sensing engagement with the print bed member. An advantage of the echo-sonar displacement sensor is its resistance to external disturbances such as vibration, infrared and EM radiation as well as ambient noise and the like.

According to a further aspect of the present invention a vertical probing method of the type defined in the preamble is provided comprising the steps of a) moving a print bed member and a nozzle head assembly toward one another from a distal sensing distance to a proximal sensing distance between a sensing surface of a contactless sensor member and the print bed member; wherein one of the nozzle ends of one or more nozzle bodies is closest to the print bed member; b) continuously measuring a change in displacement of the sensing surface by the contactless sensor member between the distal and proximal sensing distance; c) comparing the measured change in displacement to an expected change in displacement of the sensing surface; and d) halting movement between the print bed member and the nozzle head assembly upon detection of a difference between the measured change in displacement and the expected change in displacement, and then assigning a zero level distance between the one of the nozzle ends and the print bed member.

An important advantage of the vertical probing method of the present invention is that only a relative change in displacement between the print bed member and nozzle head assembly is determined whilst performing the method. As a result, the method step of moving the print bed member and the nozzle head assembly toward one another may comprise moving the print bed member toward the nozzle head assembly whilst keeping the nozzle head assembly stationary, or moving the nozzle head assembly toward the print bed member whilst keeping the print bed member stationary. With any of these embodiments accurate print bed levelling can be obtained. According to an even further aspect of the present invention a lateral scanning method of the type defined in the preamble is provided comprising the steps of a) positioning the nozzle head assembly at a planar starting position and at a scanning distance between the sensing surface of the contactless sensor member and the upper surface of the print bed member, the scanning distance being sufficiently large to provide a clearance between each nozzle end and the upper surface of the print bed member; b) laterally moving the nozzle head assembly along and relative to the print bed member, and during lateral motion between the nozzle head assembly and the print bed member, c) measuring a position of the nozzle head assembly with respect to the print bed member concurrent with taking a contactless measurement by the contactless sensor member when in sensing engagement with the print bed member; and d) repeating method step c) a predefined number of times.

Lateral scanning according to this method increases the speed at which a surface map of the print bed member can be obtained, particularly when many locations of the upper surface of the print bed member need to be analysed for accurate position calibration of one or more nozzle bodies relative to the print bed member. In an advantageous embodiment, upon completion of method step c) the measured position of the nozzle head assembly and corresponding contactless measurement can be analysed in real-time, thus without any considerably delay once the position and contactless measurements are available. This further increases the speed at which a surface map of the print bed member can be obtained.

### SHORT DESCRIPTION OF DRAWINGS

The present invention will be discussed in more detail hereinafter based on a number of exemplary embodiments with reference to the drawings, in which

FIG. 1 shows a three dimensional view of a print bed levelling system according to the present invention;

FIG. 2 shows a side view of an embodiment of a nozzle head assembly at a distal position to a print bed member according to the present invention;

FIG. 3 shows a side view of an embodiment of a nozzle end of a nozzle body in contact engagement with a print bed member according to the present invention;

FIGS. 4 and 5 each show a side view of an embodiment of two nozzle bodies of which one nozzle end is in contact engagement with a print bed member according to the present invention; and

FIG. 6 shows a schematic view of a laterally moving nozzle head assembly along a print bed member for print bed levelling according to an embodiment of the present invention.

### DETAILED DESCRIPTION OF EXEMPLARY EMBODIMENTS

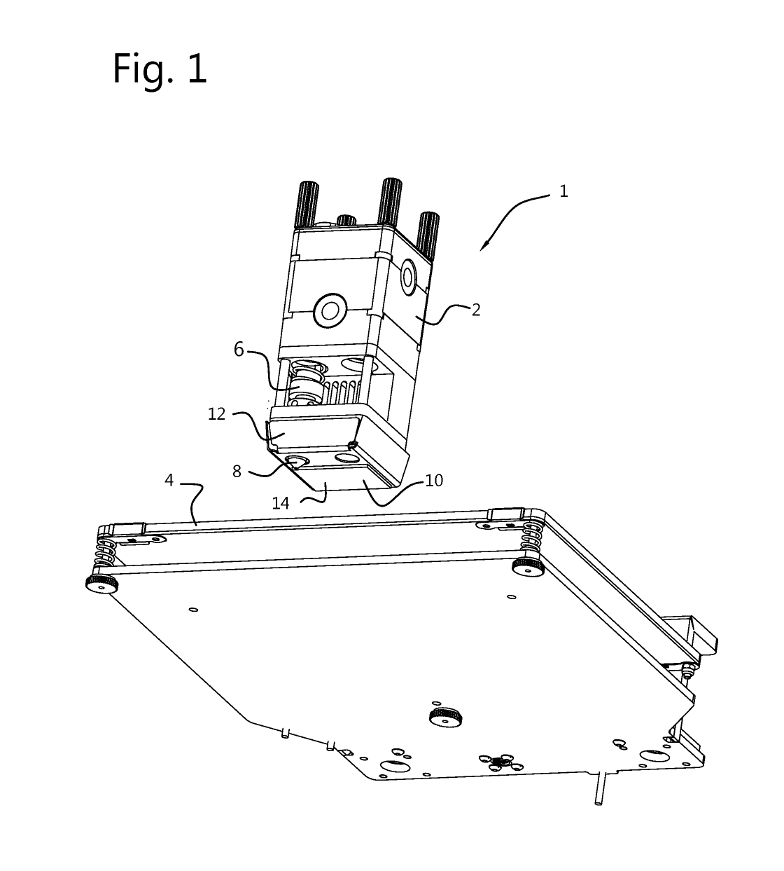

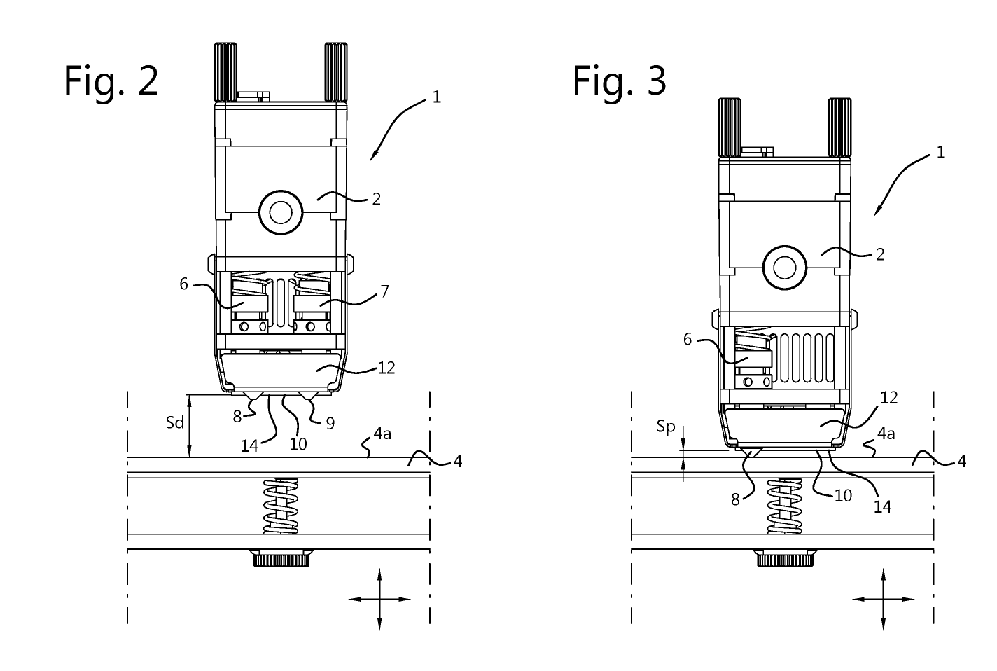

FIGS. 1 and 2 show a three dimensional view and side view, respectively, of a print bed levelling system according to the present invention. In the embodiments shown, the print bed levelling system 1 comprises a nozzle head assembly 2 movably arranged with respect to a substantially flat print bed member 4. The nozzle head assembly 2 comprising one or more nozzle bodies 6, 7 each having a nozzle end 8, 9. The nozzle end 8, 9 of each nozzle body 6, 7 is arranged to deposit material for e.g. additively building a three dimensional object, which object is deposited and built on the print bed member 4 and an upper surface 4a thereof. In a typical embodiment, the print bed levelling system utilizes an extrudable material for building an object whereas in other embodiments printable ink may be deposited by each of the nozzle bodies 6, 7. Hence, the present invention is not limited to what material is being deposited.

The nozzle head assembly 2 is further provided with a contactless sensor member 10 disposed at a print bed engagement end 12 of the nozzle head assembly 2. The contactless sensor member 10 comprises a sensing surface 14 which is in sensing engagement with the print bed member 4 over a relative sensing distance range between a distal sensing position and a proximal sensing position.

In the distal sensing position the nozzle head assembly 2 is positioned further away from the print bed member 4 and upper surface 4a thereof than in the proximal sensing position wherein the nozzle head assembly 2 is positioned closer to the print bed member 4 and upper surface 4a thereof. In FIG. 2 the nozzle head assembly 2 is depicted in the distal sensing position Sd with respect to the upper surface 4a of the print bed member 4 and.

In an embodiment, the print bed member 4 is movably arranged in horizontal and/or vertical direction relative to the nozzle head assembly 2 as indicated by arrows in FIG. 2. Furthermore, in another embodiment the nozzle head assembly 2 may be movably arranged in horizontal and/or vertical directions relative to the print bed member 4 as indicated by arrows in FIG. 2.

In an embodiment, the sensing surface 14 of the contactless sensor member 10 is fixedly attached to the print bed engagement end 12 of the nozzle head assembly 2, thereby allowing synchronous displacement of the contactless sensor member 10 and the nozzle head assembly 2, which, in turn, allows accurate determination of positional changes of the nozzle head assembly 2 with respect to the print bed member 4 based on measurements taken by the contactless sensor member 10.

Relative displacement of the nozzle head assembly 2 with respect to the print bed member 4 and upper surface 4a, or vice versa, therefore equals a relative displacement of the contactless sensor member 10 and sensing surface 14 with respect to the print bed member 4 and upper surface 4a. This also holds for a nozzle end 8, 9 of one of the one or more nozzle bodies 6, 7 when held stationary with respect to the nozzle head assembly 2. That is, a displacement of the nozzle head assembly 2 relative to the print bed member 4 results in an equal displacement of the nozzle end 8, 9 relative to the print bed member 4 and upper surface 4a thereof, which, in turn, equals a relative displacement of the contactless sensor member 10.

In a further embodiment, the sensing surface 14 of the contactless sensor member 10 is arranged adjacent to the one or more nozzle ends 8, 9 of the one or more nozzle bodies 6, 7. This allows the contactless sensor member 10 and sensing surface 14 to take accurate measurements as the sensing surface 14 can be positioned as close as possible to the print bed member 4 and upper surface 4a thereof, minimizing possible influences of measurement disturbances and perturbing factors between the sensing surface 14 and the upper surface 4a of the print bed member 4.

In an embodiment, as shown in FIG. 1, the sensing surface 14 of the contactless sensor member 10 is a flat surface substantially parallel to the print bed member 4 and the upper surface 4a thereof. Having a substantially flat sensing surface 14 allows for a larger sensing surface 14 that increases measurement resolution and accuracy. In an exemplary embodiment, the flat sensing surface 14 comprises a surface area of at least 0,5 cm², e.g. 1 cm², allowing for a measurement resolution of the contactless sensor member 10 of less than 5 μm, i.e. measurements are accurate within 5 μm.

As depicted in FIG. 2, in an embodiment the one or more nozzle ends 8, 9 of the one or more nozzle bodies 6, 7 are positioned closer to the print bed member 4 than the sensing surface 14. In this embodiment the nozzle end 8,9 of the one or more nozzle bodies 6,7 extend beyond the sensing surface 14 in proximal direction to the print bed member 4 and upper surface 4a thereof. This allows the contactless sensor member 10 to remain contactless or non-contacting in case a nozzle end 8,9 of the one or more nozzle bodies 6, 7, contacts the print bed member 4. Furthermore, the sensing surface 14 is also prevented from being damaged should a nozzle end 8, 9 come into contact with print bed member 4.

In an embodiment, the one or more nozzle bodies 6, 7 are relatively movable with respect to one another, so that, for example, an active nozzle of the one or more nozzle bodies 6,7 can be positioned for depositing material while inactive nozzles, if any, can be positioned at a suitable position further away from the print bed member 4 relative the active nozzle to avoid interference therewith. Alternatively, each of the one or more nozzle bodies 6, 7 is moveable with respect to the sensing surface 14 of the contactless sensor member 10 between a retracted position and an extended position relative thereto. The retracted position is a position distal to the print bed member 4, or toward the sensing surface 14. The extended position is a position proximal to the print bed member 4, or away from the sensing surface 14. This embodiment is advantageous as an object can be manufactured using two or more nozzle bodies 6, 7 without having idle nozzle bodies interfering with an active nozzle body. That is, an active nozzle body may be in the extended position relative to the sensing surface 14 whilst depositing material, whereas one or more non-active nozzle bodies may be in the retracted position relative to the sensing surface 14. Another advantage is that a position of a nozzle end 8, 9 of one of the one or more nozzle bodies 6, 7 may be calibrated with respect to the print bed member 4 and upper surface 4a thereof in the extended position whilst remaining nozzle bodies are in the retracted position. Due to the extended position of the one nozzle body and nozzle end thereof allows distance measurements and calibration by the contactless sensor member 10 to be uniquely associated with the currently extended nozzle body and nozzle end. In an even further embodiment, a primary nozzle of the one or more nozzle bodies 6,7 may be fixedly arranged with respect to the sensing surface 14 of the contactless sensor member 10, and one or more secondary nozzles of the one or more nozzle bodies 6,7 may be movable with respect to the primary nozzle. This embodiment may be advantageous for position calibration of the one or more secondary nozzles with respect to the primary nozzle, guaranteeing, for example, accurate positioning of each nozzle end of the one or more secondary nozzles with respect to the nozzle end of the primary nozzle.

FIG. 3 shows a side view of an embodiment of a nozzle end of a nozzle body in contact engagement with a print bed member according to the present invention. In this particular embodiment, the nozzle head assembly 2 is proximal to the print bed member 4 and upper surface 4a thereof, wherein a nozzle body 6 and nozzle end 8 are in a levelling configuration or a calibration configuration. In the levelling configuration the nozzle end 8 of the nozzle body 6 is in contact engagement with the print bed member 4, and so the nozzle end 8 cannot be positioned any closer to the print bed member 4. In the levelling configuration the contactless sensor member 10, in particular the sensing surface 14, is at the proximal sensing distance Sp, which may be envisaged as a shortest distance between the sensing surface 14 and the upper surface 4a of the print bed member 4. In a typical embodiment the proximal sensing distance Sp is bigger than zero, leaving a gap between the sensing surface 14 and the upper surface 4 in the levelling configuration.

The levelling configuration corresponds to a reference configuration wherein a distance measured at the proximal sensing distance Sp by the contactless sensor member 10 can be associated with an actual position configuration of the print bed levelling system 1. That is, the levelling configuration can be associated with a reference point from which the print bed levelling system 1 can accurately derive a position of the nozzle end 8 of the nozzle body 6 moves up and down with respect to the upper surface 4a of the print bed member 4 during an additive manufacturing process.

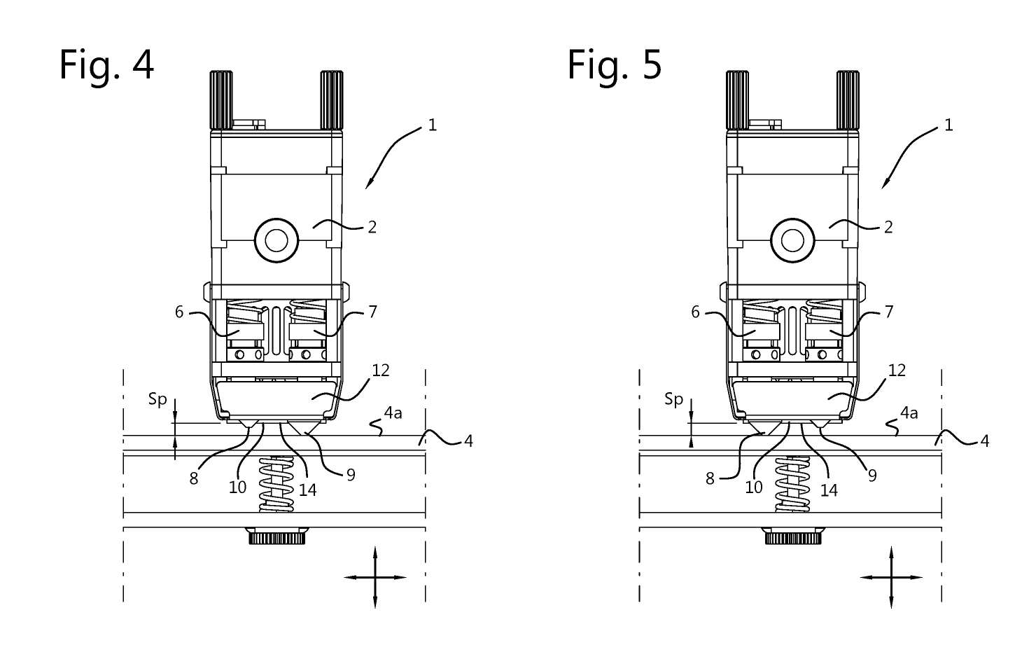

Advantageously, a plurality of levelling configurations can be utilized for a plurality of nozzle bodies 6, 7 as exemplified in FIG. 4 and FIG. 5, each figure showing a side view of an embodiment of two nozzle bodies 6,7 of which just one nozzle end 8, 9 is in contact engagement with a print bed member 4 according to the present invention.

In the embodiment shown in FIG. 4, in a first levelling configuration of the print bed levelling system 1 a first nozzle end 8 and a second nozzle end 9 of two nozzle bodies 6, 7 of the one or more nozzle bodies 6, 7 are in the retracted position and the extended position, respectively. In the first levelling configuration the proximal sensing distance Sp between the sensing surface 14 and the upper surface 4a is associated with the second nozzle end 9.

In the embodiment shown in FIG. 5, on the other hand, in a second levelling configuration of the print bed levelling system 1 the first nozzle end 8 and the second nozzle end 9 of two nozzle bodies 6, 7 of the one or more nozzle bodies 6, 7 are in the extended position and the retracted position, respectively. In the second levelling configuration the proximal sensing distance Sp between the sensing surface 14 and the upper surface 4a is associated with the first nozzle end 8.

In an advantageous embodiment, the print bed member 4 comprises electrically conductive material and the contactless sensor member 10 comprises a capacitive displacement sensor in capacitive sensing engagement with the print bed member 4. The capacitive displacement sensor is cost effective yet highly accurate in determining changes in distance between the sensing surface 14 and upper surface 4a of the print bed member 4, such as measuring the relative sensing distance range between the distal sensing position Sd and the proximal sensing distance Sp of the sensing surface 14 with respect to the print bed member 4 and upper surface 4a. The capacitive displacement sensor is also very robust to various external disturbances such as temperature changes, humidity levels, thin films of waste deposited material on the upper surface 4a of the print bed member 4 etc.

In a further embodiment, the print bed member 4 comprises electrically conductive material and the contactless sensor member 10 comprises an inductive displacement sensor in inductive sensing engagement with the print bed member 4. Inductive sensing is also cost effective, accurate, and robust to external disturbances as with capacitive sensing.

In yet a further embodiment, the contactless sensor member 10 comprises an optical displacement sensor in optical sensing engagement with the print bed member 4. This particular embodiment also allows for accurate distance measurement by the contactless sensor member 10, wherein the print bed member 4 need not comprise an electrically conductive material and can be made of any desired material suitable for optical sensing.

In yet a further embodiment, the contactless sensor member 10 comprises an echo-sonar displacement sensor or ultrasonic displacement sensor in acoustic sensing engagement with the print bed member 4. As with aforementioned embodiments of the contactless sensor member 10, this embodiment allows for displacement sensing of a relatively small, point-like upper surface area of the print bed member 4. However, an echo-sonar displacement sensor may also be readily adapted to allow for displacement sensing of larger surfaces areas of the print bed member 4 at once, e.g. an entire usable upper surface 4a of the print bed member 4.

The echo-sonar displacement sensor utilizes acoustic waves reflecting off the upper surface 4a of the print bed member 4. An advantage of the echo-sonar displacement sensor is that it does not need a particular print bed material or color to accurately measure displacements. Also, the echo-sonar displacement sensor exhibits high resistance to external disturbances such as vibration, infrared and EM radiation, and ambient noise.

In a further aspect the present invention relates to a method of print bed levelling for a print bed levelling system. Reference is made to all FIGS. 1 to 5.

The print bed levelling system 1 as disclosed above allows for cost effective yet accurate levelling of the print bed member 4 and upper surface 4a thereof with respect to the one or more nozzle bodies 6, 7, in particular nozzle ends 8, 9 thereof. Here, print bed levelling may be construed as determining an actual orientation and position of the print bed member 4 and upper surface 4a with respect to each nozzle end 8, 9 of one or more nozzle bodies 6, 7, wherein the print bed levelling system 1 itself may be subjected to manufacturing tolerances, dimensional drift due to temperature changes, humidity levels and/or contamination of various components.

The method of the present invention allows for accurate positioning of each nozzle end 8, 9 of the one or more nozzle bodies 6, 7 with respect to the upper surface 4a of the print bed member (4), wherein the method comprises the steps of

a) moving the print bed member 4 and the nozzle head assembly 2 toward one another from the distal sensing distance Sd to the proximal sensing distance Sp between the sensing surface 14 of the contactless sensor member 10 and the print bed member 4, e.g. the upper surface 4a thereof. In this method step one of the nozzle ends 8, 9 of the one or more nozzle bodies 6, 7 is closest to the print bed member 4, i.e. in the extended position relative to the sensing surface 14. The print bed levelling system 1 and the print bed member 1 is therefore being levelled for this nozzle end in question.

FIG. 2 can be viewed as a starting position of the nozzle head assembly 2 with respect to the print bed member 4 from which the present method may begin.

The method then comprises the step of

b) continuously measuring a change in displacement of the sensing surface 14 by the contactless sensor member 10 between the distal and proximal sensing distance Sd, Sp. In this step the nozzle head assembly 2 and print bed member 4 are steadily approaching whilst at the same time the contactless sensor member 10 continuously measures a relative change in displacement between the sensing surface 14 and the print bed member 4.

During continuous measurement by the contactless sensor member 10, the method proceeds with the step of

c) comparing the measured change in displacement to an expected change in displacement of the sensing surface 14. So while measuring the change in displacement, an expected change in displacement is determined and compared to the measured change in displacement by the contactless sensor member 10.

When comparing the measured and expected change in displacement, the method then comprises a conditional step of

d) halting movement between the print bed member 4 and the nozzle head assembly (2) upon detection of a difference between the measured change in displacement and the expected change in displacement, and assigning a zero level distance between the one of the nozzle ends 8,9 and the print bed member 4.

The above method allows accurate measurement of when a nozzle end of a nozzle body is contact engagement with the upper surface 4a of the print bed member 4, whereby a zero level distance can be assigned to that nozzle end with respect to the upper surface 4a. The measured proximal sensing distance Sp between the sensing surface 14 and the upper surface 4a of the print bed member 4 is then associated with the assigned zero level distance of that nozzle end.

When the method is performed by the print bed levelling system 1 of the present invention an actual location of a nozzle end relative to the print bed member 4 and upper surface 4a is determined. Manufacturing tolerances, dimensional perturbations and component misalignment as a result of e.g. temperature changes, humidly levels and/or contamination of the print bed member 4 are all accounted for.

An important advantage of the method is that only a relative sensing distance range between the distal sensing distance Sd and proximal sensing distance Sp is measured to automatically level or calibrate a position of the print bed member 4 with respect to one or more nozzle ends 8,9. A point at which a particular nozzle end is in contact engagement with the upper surface 4a of the print bed member 4 is sufficient to further derive other positions of that nozzle end with respect to the print bed member 4 as it moves relative thereto during an additive manufacturing process.

In an embodiment, the method step of d) may further comprise determining a zero level distance of the one of the nozzle ends 8,9 of the one or more nozzle bodies 6, 7 for two or more positions across the upper surface 4a of the print bed member 4. This embodiment allows for “surface mapping” of the print bed member 4 with respect to the one of the nozzle ends 8, 9. For example, a substantially flat upper surface 4a of the print bed member 4 may in fact be lightly skewed at an angle or, generally, be misaligned with respect to the print bed levelling system 1 due to e.g. manufacturing tolerances, assembly errors but also due to wear of the print bed levelling system 1 over time. In order to account for such positional misalignments, determining a zero level distance of the one of the nozzle ends 8, 9 at two or more locations across the print bed member 4 enables accurate positioning of said nozzle ends with respect to the upper surface 4a. For example, using e.g. three zero level distances across the print bed member 4 allows a plane to be determined accurately. Moreover, in an embodiment of the method it may even be possible to completely map 50% or more of the upper surface 4a. For example, by determining many zero level distances in a grid like fashion, a dense surface map may be obtained of a large number of points each of which is associated with a zero level distance as measured.

In an advantageous embodiment, the methods steps of a) to d) are performed one or more times for each nozzle end 8, 9 of the one or more nozzle bodies 6, 7. This embodiment ensures that all nozzle bodies 6, 7 and each nozzle end 8, 9 is assigned a zero level distance at one or more positions across the print bed member 4 and upper surface 4a thereof.

Another important advantage of the method of the present invention is that it does not rely on whether the print bed member 4 and the nozzle head assembly 2 are both moving or just one of the two is moving. Only a relative change in displacement between the print bed member 4 and nozzle head assembly 2 is needed whilst performing the method. It is therefore possible to have an embodiment wherein the method step of a) moving the print bed member 4 and the nozzle head assembly 2 toward one another, comprises the step of moving the print bed member 4 toward the nozzle head assembly 2 whilst keeping the nozzle head assembly 2 stationary. Conversely, there is an embodiment wherein the method step of a) moving the print bed member 4 and the nozzle head assembly 2 toward one another, comprises the step of moving the nozzle head assembly 2 toward the print bed member 4 whilst keeping the print bed member 4 stationary.

To further clarify the vertical probing method of the invention, FIGS. 4 and 5 depict different levelling configurations for determining a zero level distance between each of the two extrusions ends 8, 9 and the print bed member 4. For example, FIG. 4 depicts an embodiment wherein a first nozzle end 8 is in a retracted position with respect to the sensing surface 14 and wherein a second nozzle end 9 is in an extended position with respect to the sensing surface 14. The second nozzle end 9 is in contact engagement with the print bed member 4 and upper surface 4a thereof. The sensing surface 14 is at the proximal sensing distance Sp relative to the print bed member 4 and upper surface 4a thereof. In this levelling configuration and according to the method as outlined above, movement between the print bed member 4 and nozzle head assembly 2 is halted as a difference between a measured change in displacement and an expected change in displacement will be detected by the contactless sensor member 10. At that moment, according to the invention, it is now possible to assign a zero level distance to the second nozzle end 9 and determine the position of the print bed member 4 relative to the second nozzle end 9.

FIG. 5 depicts a further levelling configuration, wherein a first nozzle end 8 is in the extended position with respect to the sensing surface 14 and wherein the second nozzle end 9 is in the retracted position instead. In this case the first nozzle end 8 is in contact engagement with the print bed member 4 and upper surface 4a thereof. This time the sensing surface 14 is at the proximal sensing distance Sp relative to the print bed member 4 and upper surface 4a thereof and will now be associated with a zero level distance for the first nozzle end 8. The above mentioned method step d) is now performed by halting movement as a difference between the measured change in displacement and the expected in displacement will be detected, wherein a zero level distance can be assigned between the first nozzle end 8 and the print bed member 4 and upper surface 4a thereof.

The method as described above can be summarized in that a vertical or orthogonal/perpendicular probing direction is utilized, which means that at a plurality of different positions along the upper surface 4a of the print bed member 4 the nozzle head assembly 2 moves vertically or orthogonally relative to the upper surface 4a in continuous and smooth fashion between the distal sensing distance Sd and the proximal sensing distance Sp. During this vertical/orthogonal movement, the nozzle head assembly 2 remains fixed in planar sense with respect to the print bed member 4.

The vertical probing method by moving the nozzle head assembly 2 and print bed member 4 closer to one another whilst keeping the planar/lateral position fixed allows for accurate calibration of the print bed member 4 with respect to the one or more nozzle ends 8, 9. However, such a process may become time consuming when the number of planar positions to be probed increases significantly.

Instead of vertically or orthogonally probing through the method explained above, it may be advantageous to utilize a horizontal scanning technique. For example, the nozzle head assembly 2 can be positioned at some planar starting position with respect to the upper surface 4a of the print bed member 4, and where the nozzle head assembly 2 is positioned at a scanning distance Ss between the sensing surface 14 and the upper surface 4a of the print bed member 4. At this scanning distance Ss, sufficient clearance is provided such that none of the nozzle ends 8, 9 touch the print bed member 4. Subsequently, a scanning mode is initiated by laterally/horizontally moving the nozzle head assembly 2 along the upper surface 4a of the print bed member 4, during which planar/horizontal positions (e.g. X-Y coordinates) and height/vertical positions (e.g. Z-coordinates) of the nozzle head assembly 2 can be measured concurrent with contactless measurements taken by the contactless sensor member 10.

It is not necessary for the nozzle head assembly 2 to stop at any position as long as each contactless measurement taken by the contactless sensor member 10 is clearly related to a corresponding position of the nozzle head assembly 2. This is achieved through measuring the position of the nozzle head assembly 2 and by taking the contactless measurement concurrently, i.e. simultaneously, thereby associating the contactless measurement with a current position of the nozzle head assembly 2.

The speed at which the print bed member 4 can be laterally scanned depends on, for example, the processing system and the type of contactless sensor member 10 used, but also the drive system and servo control for moving the nozzle head assembly 2 and print bed member 4 with respect to each other.

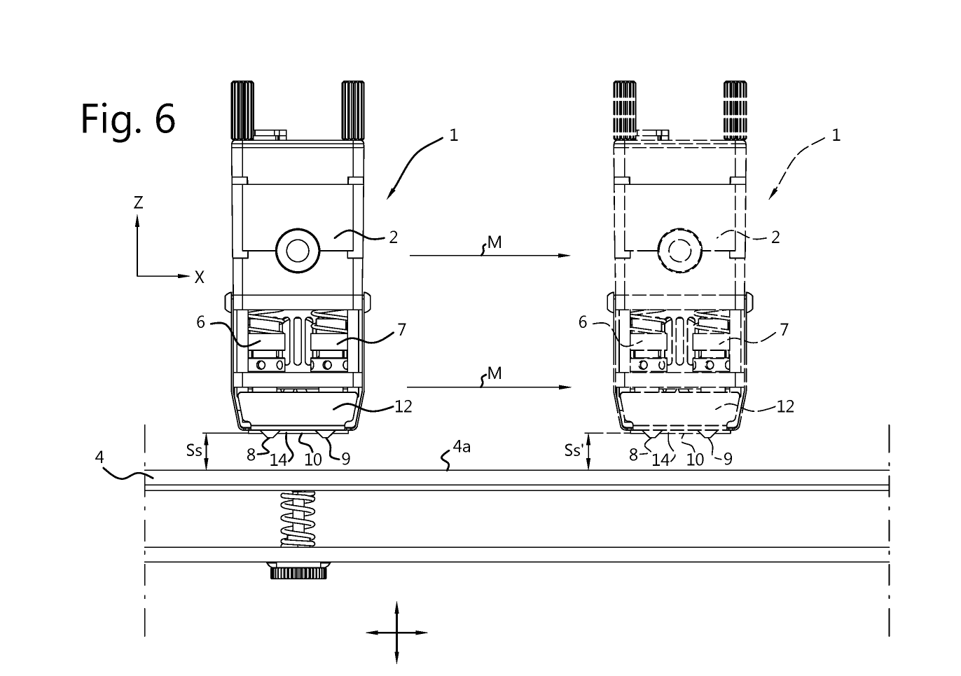

FIG. 6 shows a schematic view of a laterally moving nozzle head assembly 2 along a print bed member 4 for print bed levelling according to an embodiment of the present invention. As depicted and as outlined above, the lateral scanning method can be defined as comprising the steps of

a) positioning the nozzle head assembly 2 at a planar starting position and at a scanning distance Ss between the sensing surface 14 of the contactless sensor member 10 and the upper surface 4a of the print bed member 4, wherein the scanning distance Ss is sufficiently large to provide a clearance between each nozzle end 8, 9 and the upper surface 4a of the print bed member 4;

b) laterally moving the nozzle head assembly 2 along and relative to the print bed member 4, and while laterally moving the nozzle head assembly 2 along the print bed member 4,

c) measuring a position of the nozzle head assembly 2 with respect to the print bed member 4 concurrent with taking a contactless measurement by the contactless sensor member 10 when in sensing engagement with the print bed member 4; and

d) repeating method step c) a predefined number of times. [text of claim 16]

In this method, when repeating step c) it is understood that step b) of laterally moving the nozzle head assembly 2 is continued while measuring a current position of the nozzle head assembly 2 and simultaneously taking a contactless measurement by the contactless sensor member 10 at the current position. So as the nozzle head assembly 2 moves laterally, various positions of the nozzle head assembly 2 are measured as well as corresponding contactless measurements at those positions.

In an embodiment the method may explicitly comprise a final step e) of stopping the lateral movement of the nozzle head assembly 2 at a planar end position when method step c) has been repeated according to the predetermined number of times. Without loss of generality, however, one may assume that a planar end position has actually been reached when all required measurements have been taken.

The lateral motion of the nozzle head assembly 2 is schematically depicted as parallel arrows M when moving from a planar starting position (left) to a planar end position (right). The position of the nozzle head assembly 2 as mentioned in method step c) above is typically represented in a Cartesian (X,Y,Z) coordinate system, where vertical/orthogonal displacement of the nozzle head assembly 2 with respect to the upper surface 4a is defined in the Z direction as shown in FIG. 6. The Z direction may also be seen as the height of the nozzle head assembly 2 with respect to the print bed member 4. The planar (starting) position of the nozzle head assembly 2, i.e. in a plane substantially parallel to the upper surface 4a, may be seen as an (X,Y) coordinate. Note that the Y direction in FIG. 6 is perpendicular to the Z and X directions as shown (i.e. into the paper). Even though the lateral motion M of the nozzle head assembly 2 in the depicted embodiment is in the X direction only, lateral motion of the nozzle head assembly 2 may occur along any path in the X-Y plane.

To further clarify method step a), the planar starting position of the nozzle head assembly 2 may be any X-Y position with respect to the upper surface 4a of the print bed member 4, so it need not be a position near or at a corner of the upper surface 4a. This also applies to the planer end position as mentioned above, which could be any X-Y position of choice.

Further, the scanning distance Ss refers to a distance between the sensing surface 14 of the contactless sensor member 10 and the upper surface 4a of the print bed member 4. When a desired scanning distance Ss is determined, then a Z position of the nozzle head assembly 2 is determined. The converse is also true, i.e. when the nozzle head assembly 2 is assigned some Z position (i.e. a vertical/orthogonal position), then the sensing distance Ss follows. Therefore, the scanning distance Ss may be a parameter that follows from a chosen Z position of the nozzle head assembly 2 at the planar starting position.

In any case, the scanning distance Ss should provide sufficient clearance between each nozzle end 8, 9 such that the nozzle head assembly 2 can laterally move along the entire upper surface 4a of the print bed member 4 without allowing any contact between nozzle ends 8, 9 and the upper surface 4a. However, the scanning distance Ss should also be chosen such that good sensing engagement (“coupling”) is achieved and maintained between the contactless sensor member 10 and the print bed member 4 for all X-Y positions of the nozzle head assembly 2.

In an embodiment, the step of laterally moving the nozzle head assembly 2 along and relative to the print bed member 4 comprises providing lateral motion between the nozzle head assembly 2 and the print bed member 2 at a constant velocity. This embodiment allows for steady lateral motion of the nozzle head assembly 2 so that an even distribution is obtained for the measurements of the position of the nozzle head assembly 2 concurrent with the contactless measurements along the upper surface 4a.

Advantageously, the print bed member 4 can be scanned in any resolution required by taking measurements in quick succession and as fast as the processing system and motor control permits. For example, in an embodiment method steps c) may be repeated 50 to 150 times per second, e.g. 100 times per second, thereby providing sufficient sampling resolution for a wide range of lateral speeds of the nozzle head assembly 2 to obtain an accurate surface map of the upper surface 4a.

In an exemplary embodiment, method step b) of laterally moving the nozzle head assembly 2 may be performed at a lateral speed of 100 mm to 300 mm per second, e.g. 200 mm per second, and wherein during lateral motion method step c) of measuring a position of the nozzle head assembly 2 and concurrently taking a contactless measurement with the contactless sensor member is repeated 50 to 150 times per second, e.g. 100 times per second.

When scanning the print bed member 4, it is possible to analyse the measurements as soon as they come in during lateral motion of the nozzle head assembly 2 or to analyse the measurements in batch wise fashion, e.g. when a subset of measurements have been completed or when all measurements have been completed.

In an exemplary embodiment, upon completion of method step c) the method may further comprise the step of analysing the measured position of the nozzle head assembly 2 concurrent with the contactless measurement of the contactless sensor member 10 in real-time. In this embodiment, the position measurement and contactless measurement are to be analysed as soon as these measurements are available such that a “surface map” or “height map” of the upper surface 4a is progressively determined and with greater speed.

In an alternative embodiment, the method step of c) may comprises storing the measured position of the nozzle head assembly 2 and the contactless measurement of the contactless sensor 10 until a predefined number of stored measurements has been reached, and subsequently analysing the stored measurements. Therefore, when the method step c) is repeated up to the predefined number of stored measurements, the position measurements and associated contactless measurements are successively stored and when the predefined number of stored measurements is reached, the calibration analysis of the upper surface 4a can start based on the collected batch of measurements. Such batch wise analysis may be advantageous in case there are insufficient resources available for real-time processing, e.g. when complex analysis is to be carried out or when the measurement frequency is high.

As an extension of batch wise processing, all measurements can be stored until the entire scanning process has been completed, so there may be an embodiment wherein the predefined number of stored measurements equals the predefined number of times the method step c) has been repeated. In this case the analysis is performed on the entire collection of positions and associated contactless measurements, thereby providing a single data set that can be analysed as a whole, allowing for complex analysis to further improve calibration accuracy.

The method for scanning the print bed member 4 as outlined above can be further explained by considering the following. When method step a) is completed and the nozzle head assembly 2 has acquired the planar starting position and a Z-position providing the scanning distance Ss, then the nozzle head assembly 2 can be laterally moved by a drive system such that the Z-position of the nozzle head assembly 2 is held constant with respect to a frame of the print bed levelling system 1. Doing so allows the scanning distance Ss to vary and measured during lateral motion in correspondence to changes of the upper surface 4a of the print bed member 4. The measured changes of the scanning distance Ss through changes of the upper surface 4a can then be used for calibration/levelling of the print bed member 4. This process is further clarified in FIG. 6 where the nozzle head assembly 2 (left) assumes a scanning distance Ss as prescribed by method step a). During lateral motion M as indicated the displaced nozzle head assembly 2 (right) now measures a varied scanning distance Ss′. These changes of scanning distance from Ss to Ss′ are used for the calibration analysis.

In alternative fashion, an embodiment is provided wherein the scanning method allows the scanning distance Ss between the sensing surface 14 and the upper surface 4a to remain constant through drive system control, e.g. servo control, of the nozzle head assembly 2. For example, in such an embodiment the scanning distances Ss and Ss′ depicted in FIG. 6 are held (substantially) constant, so Ss=Ss′ as the nozzle head assembly 2 moves along the print bed member 4. The method step of c) measuring the position of the nozzle head assembly 2 concurrent with the contactless measurement then comprises vertically/orthogonally moving the nozzle head assembly 2 relative to the print bed member 4, i.e. the upper surface 4a, to keep the scanning distance Ss (substantially) constant based on the measured contactless measurements. In this embodiment the Z position of the nozzle head assembly 2 is actively controlled during lateral motion to keep the scanning distance Ss constant. Changes in the Z direction when laterally moving the nozzle head assembly 2 then provides a direct measurement of height changes in the upper surface 4a of the print bed member 4.

Even though the vertical probing and scanning methods have been described as separate methods, it is conceivable that these methods can be combined to further improve the print bed levelling/calibration process.

For example, the main goal of print bed levelling/calibration is to determine actual distances between each nozzle end 8, 9 and the upper surface 4a of the print bed member 4 over a largest possible build portion of the upper surface 4a. However, nearly every structural part/component of the print bed levelling system 1 connecting the upper surface 4a of the print bed member 4 to each nozzle end 8,9 introduces dimensional tolerances, errors, offsets etc. By combining the vertical probing and lateral scanning methods, it is possible to further improve the identification and separation of various inaccuracies of the print bed levelling system 1 itself

Furthermore, such a combination of vertical probing and lateral scanning allows for accurate mapping of the entire upper surface 4a of the print bed member 4, where a set of planar positions (X,Y) are spaced apart across the upper surface 4a for vertical probing and where the scanning method is used to laterally move the nozzle head assembly 2 between these planar positions.

Based on these considerations, a combined method is thus conceivable of print bed levelling for a print bed levelling system wherein the method comprises the first step of

a) selecting a plurality of different positions along the upper surface 4a of the print bed member 4. These plurality of positions are chosen such that the upper surface 4a of the print bed member 4 is sufficiently covered. The method then proceeds with the step of

b) performing the vertical probing method at a first position of the plurality of different positions. In this step a first position of the plurality of positions is selected at which the vertical probing technique is to be performed, i.e. moving the nozzle head assembly 2 and the print bed member 4 closer to one another whilst keeping the planar/lateral position fixed. When the zero level distance has been assigned between one or more nozzle ends 8, 9 and the print bed member 4 at the end of the vertical probing method, then the scanning method can start through the method step of

c) performing the method of claim 16 by taking the first position as the planar starting position, and wherein laterally moving the nozzle head assembly 2 is performed in a direction toward a second position of the plurality of different positions.

In this step the nozzle head assembly 2 laterally moves in the direction of a second position selected from the plurality of different positions. As the nozzle head assembly 2 moves between the first and second positions, the scanning method is performed by repeatedly measuring the position of the nozzle head assembly 2 with respect to the print bed member 4 concurrent with taking the contactless measurement with the contactless sensor member. When the second position has been reached, then the vertical probing method can start again at the second position, so that the method continues with the step of

d) performing the method of claim 12 at the second position of the plurality of different positions.

So in summary, by successively switching between the vertical probing and lateral scanning methods, the upper surface 4a of the print bed member 4 can be analysed in systematic fashion and with great detail as each position of the plurality of different positions is probed in vertical fashion whilst the scanning method scans the print bed member 4 at high sampling frequency between different positions along some desired sequence of positions across the print bed member 4.

The present invention embodiments have been described above with reference to a number of exemplary embodiments as shown in and described with reference to the drawings. Modifications and alternative implementations of some parts or elements are possible, and are included in the scope of protection as defined in the appended claims.

1. A method of print bed levelling for a print bed levelling system comprising a nozzle head assembly movably arranged with respect to a substantially flat print bed member, the nozzle head assembly comprising one or more nozzle bodies each having a nozzle end, and a contactless sensor member disposed at a print bed engagement end of the nozzle head assembly, wherein the contactless sensor member comprises a sensing surface in sensing engagement with the print bed member; the method comprising the steps of:
a) moving the print bed member and the nozzle head assembly toward one another from a distal sensing distance to a proximal sensing distance between the sensing surface of the contactless sensor member and the print bed member; wherein one of the nozzle ends of one or more nozzle bodies is closest to the print bed member;
b) continuously measuring a change in displacement of the sensing surface by the contactless sensor member between the distal and proximal sensing distance;
c) comparing the measured change in displacement to an expected change in displacement of the sensing surface; and
d) halting movement between the print bed member and the nozzle head assembly upon detection of a difference between the measured change in displacement and the expected change in displacement, and then assigning a zero level distance between the one of the nozzle ends and the print bed member.

2. The method according to claim 1, wherein the method further comprises the step of determining a zero level distance of the one of the nozzle ends of the one or more nozzle bodies for two or more positions across an upper surface of the print bed member.

3. The method according to claim 1, wherein the methods steps of a) to d) are performed one or more times for each nozzle end of the one or more nozzle bodies.

4. The method according to claim 1, wherein the method step of a) moving the print bed member and the nozzle head assembly toward one another, comprises the step of moving the print bed member toward the nozzle head assembly whilst keeping the nozzle head assembly stationary, or moving the nozzle head assembly toward the print bed member whilst keeping the print bed member stationary.

5. A method of print bed levelling for a print bed levelling system comprising a nozzle head assembly movably arranged with respect to a substantially flat print bed member, the nozzle head assembly comprising one or more nozzle bodies each having a nozzle end, and a contactless sensor member disposed at a print bed engagement end of the nozzle head assembly, wherein the contactless sensor member comprises a sensing surface in sensing engagement with the print bed member; the method comprising the steps of:
a) positioning the nozzle head assembly at a planar starting position and at a scanning distance between the sensing surface of the contactless sensor member and an upper surface of the print bed member, the scanning distance being sufficiently large to provide a clearance between each nozzle end and the upper surface of the print bed member;
b) laterally moving the nozzle head assembly along and relative to the print bed member, and during lateral motion between the nozzle head assembly and the print bed member,
c) measuring a position of the nozzle head assembly with respect to the print bed member concurrent with taking a contactless measurement with the contactless sensor member when in sensing engagement with the print bed member; and
d) repeating method step c) a predefined number of times.

6. The method according to claim 5, wherein the step of laterally moving the nozzle head assembly along and relative to the print bed member comprises providing lateral motion between the nozzle head assembly and the print bed member at a constant velocity.

7. The method according to claim 5, wherein method step b) is performed at a lateral speed between 100 mm to 300 mm per second, and wherein method step c) is repeated 50 to 150 times per second.

8. The method according to claim 5, wherein upon completion of method step c), the method further comprises analysing the measured position of the nozzle head assembly and contactless measurement in real-time.

9. The method according to claim 5, wherein the method step of c) comprises storing the measured position of the nozzle head assembly and the contactless measurement of the contactless sensor until a predefined number of stored measurements has been reached, and subsequently analysing the stored measurements.

10. The method according to claim 9, wherein the predefined number of stored measurements equals the predefined number of times for repeating the method step c).

11. The method according to claim 5, wherein the step of c) measuring the position of the nozzle head assembly concurrent with the contactless measurement comprises orthogonally moving the nozzle head assembly relative to the print bed member to keep the scanning distance substantially constant based on the measured contactless measurement.

12. A method of print bed levelling for a print bed levelling system comprising a nozzle head assembly movably arranged with respect to a substantially flat print bed member, the nozzle head assembly comprising one or more nozzle bodies each having a nozzle end, and a contactless sensor member disposed at a print bed engagement end of the nozzle head assembly, wherein the contactless sensor member comprises a sensing surface in sensing engagement with the print bed member; the method comprising the steps of:
a) selecting a plurality of different positions along an upper surface of the print bed member; then
b) performing the following vertical probing method at a first position of the plurality of different positions, the vertical probing method being performed with the print bed levelling system:
i) moving the print bed member and the nozzle head assembly toward one another from a distal sensing distance to a proximal sensing distance between the sensing surface of the contactless sensor member and the print bed member; wherein one of the nozzle ends of the one or more nozzle bodies is closest to the print bed member;
ii) continuously measuring a change in displacement of the sensing surface by the contactless sensor member between the distal and proximal sensing distance;
iii) comparing the measured change in displacement to an expected change in displacement of the sensing surface; and
iv) halting movement between the print bed member and the nozzle head assembly upon detection of a difference between the measured change in displacement and the expected change in displacement, and then assigning a zero level distance between the one of the nozzle ends and the print bed member.

13. The method of claim 12, and further comprising the step of:
c) performing the following lateral scanning method with the print bed levelling system by taking the first position as a planar starting position and selecting a second position of the plurality of different positions:
v) positioning the nozzle head assembly at the planar starting position and at a scanning distance between the sensing surface of the contactless sensor member and the upper surface of the print bed member, the scanning distance being sufficiently large to provide a clearance between each nozzle end and the upper surface of the print bed member;
vi) laterally moving the nozzle head assembly along and relative to the print bed member in a direction toward the selected second position, and during lateral motion between the nozzle head assembly and the print bed member,
vii) measuring a position of the nozzle head assembly with respect to the print bed member concurrent with taking a contactless measurement with the contactless sensor member when in sensing engagement with the print bed member; and
viii) repeating method step vii) a predefined number of times.

14. The method of claim 13, and further comprising the step of performing the vertical probing method of step b) at the selected second position once the lateral scanning method of step c) has finished.

15. The method of claim 13, wherein the step vi) of laterally moving the nozzle head assembly along and relative to the print bed member comprises providing lateral motion between the nozzle head assembly and the print bed member at a constant velocity.

16. The method of claim 15, wherein the constant velocity lies between 100 mm to 300 mm per second, and wherein the step vii) of measuring the position of the nozzle head assembly concurrent with taking the contactless measurement is repeated 50 to 150 times per second.

17. The method of claim 13, wherein upon completion of step vii) the lateral scanning method further comprises analysing the measured position of the nozzle head assembly and the contactless measurement in real-time.

18. The method of claim 13, wherein the step vii) further comprises storing the measured position of the nozzle head assembly and the contactless measurement of the contactless sensor until a predefined number of stored measurements has been reached, and subsequently analysing the stored measurements.

19. The method of claim 18, wherein the predefined number of stored measurements equals the predefined number of times for repeating step vii) according to step viii).

20. The method of claim 13, wherein the step vii) of measuring the position of the nozzle head assembly concurrent with the contactless measurement further comprises orthogonally moving the nozzle head assembly relative to the print bed member to keep the scanning distance during lateral motion substantially constant based on the contactless measurement.
